(19) United States
(12) Patent Application Publication
(10) Pub. No.: US 2009/0232161 A1
(43) Pub. Date: Sep. 17, 2009

(54) HIERARCHICAL HEADER FORMAT AND DATA TRANSMISSION METHOD IN COMMUNICATION SYSTEM

(75) Inventors: Geon-Min YEO, Daejeon (KR); Kang-Hee Kim, Busan (KR); Byung-Han Ryu, Daejeon (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute; Samsung Electronics Co., Ltd.,

(21) Appl. No.: 12/474,922

(22) Filed: May 29, 2009

Related U.S. Application Data
(63) Continuation of application No. PCT/KR2007/006140, filed on Nov. 30, 2007.

(30) Foreign Application Priority Data
Dec. 1, 2006 (KR) 10-2006-0120599
Nov. 27, 2007 (KR) 10-2007-0097549

(51) Int. Cl. H04J 3/24

(52) U.S. Cl. 370/473

(57) ABSTRACT

In order to transmit data between layers in a communication system, and ARQ controller determines a transmission method of a service packet according to QoS of the service packet of an upper layer, determines a retransmission method of the service packet according to the transmission method, generates a fragmentation block by fragmentizing and concatenating the service packet according to a transmission amount of the service packet determined by the transmission method, generates a data packet including the fragmentation block and fragmentation block information, adds radio link control information including the retransmission method to the data packet to generate a radio link control data packet, and transmits the radio link control data packet to a MAC layer.

### TECHNICAL FIELD

The present invention relates to a hierarchical header format and a data transmission method in a communication system.

This work was supported by the IT R&D program of MIC/IITA [2005-S-404-12, Research & Development of Radio Transmission Technology for 3G Evolution].

### BACKGROUND ART

Communication systems require security of transmitted data. The security is more important in wireless communication systems than wired communication systems. The security is a function for preventing transmitted data from being lost or damaged. Various methods are used so as to prevent loss or damage in transmitted data in communication systems. One of the methods is the automatic repeat request (ARQ) method. The ARQ method is a method in which, when a receiver fails to receive predetermined data from a transmitter or fails to decode the data, the failure is notified to the transmitter so that the transmitter may transmit the data again.

The transmitter divides a service data unit (SDU) of a medium access control (MAC) protocol into ARQ blocks and transmits the same to the receiver. The receiver notifies the transmitter of the receiving status of the respective ARQ blocks. In this instance, the transmitter and the receiver must identify the transmitted blocks because it is possible to know which blocks the receiver has received and whether the receiver will request an ARQ for a predetermined block when they have identified the blocks. In order to identify the respective blocks, a block sequence number for identifying the transmitted blocks is applied to the respective blocks.

However, since the ARQ method transmits data in a fixed manner according to a predetermined transmission amount, radio resources may be wasted when there is not a large amount of transmitted data.

The above information disclosed in this Background section is only for enhancement of understanding of the background of the invention and therefore it may contain information that does not form the prior alt that is already known in this country to a person of ordinary skill in the art.

### DISCLOSURE OF INVENTION

### Technical Problem

The present invention has been made in an effort to provide a header format for efficiently using radio resources and processing data at a high data rate in the case of transmitting data between layers in a communication system.

### Technical Solution

In one aspect of the present invention, a method for transmitting data between layers in a communication system includes: determining a transmission method for a service packet according to quality of service (QoS) of the service packet; determining a transmission amount of the service packet according to the transmission method; fragmentizing and concatenating the service packet according to the transmission amount and generating at least one fragmentation block; generating a data packet including the at least one fragmentation block and information on the at least one fragmentation block; inserting information on the number of fragmentation blocks into the data packet; and transmitting the data packet.

The determining of a transmission method for a service packet includes selecting one of a transparent mode, an acknowledged mode, and an unacknowledged mode depending on the QoS requested by the service packet.

In another aspect of the present invention, a method for generating a data packet includes: fragmentizing and concatenating a service packet of an upper layer according to a transmission amount of a service packet, and generating at least one fragmentation block; inserting at least one fragmentation block information field corresponding to the at least one fragmentation block into the data packet; inserting the at least one fragmentation block into the data packet; and inserting information on the data packet into the data packet.

In another aspect of the present invention, a method for generating a transmission block includes: determining a transmission method for a service packet according to a quality of service (QoS) of the service packet; fragmentizing and concatenating the service packet according to a transmission amount of the service packet, and generating a fragmentation block; generating a data packet including the fragmentation block and information on the fragmentation block; generating a control packet for controlling data transmission according to the transmission method; generating the transmission block including the at least one data packet and the control packet; and inserting information on the transmission block into the transmission block.

According to the exemplary embodiments of the present invention, it is possible to efficiently use the radio resource and efficiently process data with a high data rate by using the hierarchical header format.

### BRIEF DESCRIPTION OF THE DRAWINGS

FIG. 1 is a block diagram for a communication system according to an exemplary embodiment of the present invention.

FIG. 2 is a flowchart for a data transmission method by an ARQ controller according to an exemplary embodiment of the present invention.

FIG. 3 is a configuration of a TB of a MAC layer and a header field of the TB according to an exemplary embodiment of the present invention.

FIG. 4 and FIG. 5 show a first type and a second type of RLC PDU of a payload field of a TB according to an exemplary embodiment of the present invention.

FIG. 6 shows an RLC information field of an RLC PDU of a TB according to an exemplary embodiment of the present invention.

FIG. 7 and FIG. 8 show a first type and a second type of FB information field of an RLC PDU of a TB according to an exemplary embodiment of the present invention.

FIG. 9 shows a configuration of an RLC control PDU according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms “unit”, “device”, and “module” in the present specification represent a unit for processing a predetermined function or operation, which can be realized by hardware, software, or a combination of hardware and software.

A hierarchical header format and a data transmission method in a communication system according to an exemplary embodiment of the present invention will be described.

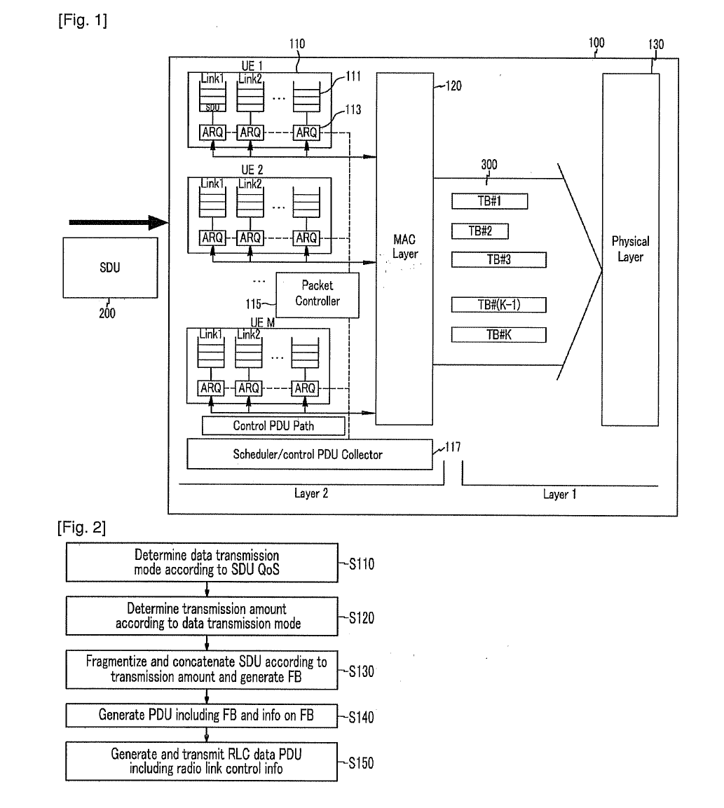

FIG. 1 is a block diagram for a communication system 100 according to an exemplary embodiment of the present invention.

As shown in FIG. 1, the communication system 100 includes a terminal information storage unit 110, a packet controller 115, and a scheduler/control protocol data unit (PDU) collector 117, and the terminal information storage unit 110 includes a buffer 111 and an ARQ controller 113.

The buffer 111 of the terminal information storage unit 110 receives an SDU from an upper layer and temporarily stores the SDU.

The ARQ controller 113 includes functions of a general radio link control (RLC) layer including a retransmission function for providing great data accuracy. Also, the ARQ controller 113 determines a data transmission mode based on the QoS of an SDU 200 stored in the buffer 111. Here, the data transmission mode includes a transparent mode, an acknowledged mode, and an unacknowledged mode.

The transparent mode is generated when the ARQ controller 113 provides no overhead to the FB that is transmitted by an upper layer when generating an RLC PDU. Hence, the transparent mode is appropriate for services that have great requirements on the real-time transmission.

The acknowledged mode is generated when the ARQ controller 113 adds a PDU header including a sequence number (SN) to the payload of the PDU when generating the PDU, and a receiver responds to the PDU transmitted by a transmitter. The response is provided so that the receiver may request the transmitter to retransmit the PDU that is not received by the receiver. Since the acknowledged mode guarantees data transmission without an error, the acknowledged mode is appropriate for the services that have a low requirement for the real-time transmission and have a great requirement for the data accuracy.

The unacknowledged mode allows the receiver to know which PDU is lost during transmission since the ARQ controller 113 of the transmitter adds a PDU header including a sequence number to each PDU and transmits the PDU. Therefore, the unacknowledged mode is appropriate for the service that has requirements for the real-time transmission and the packet sequence.

The packet controller 115 collects various RLC control PDUs through the scheduler/control PDU collector 117 according to the data transmission mode determined by the ARQ controller 113, and transmits the collected RLC control PDUs to a MAC layer 120 and the ARQ controller 113 by considering the resource allocation condition and using scheduler-based allocation, piggybagging, or indication bit insertion.

The MAC layer 120 receives an RLC data PDU from the ARQ controller 113, receives an RLC control PDU from the packet controller 115, multiplexes them to configure a transport block (TB) 300 that is appropriate for the radio channel, and transmits the transport block to the physical layer 130.

Here, the TB 300 is configured to provide the hybrid ARQ (HARQ) and multi-input multi-output (MIMO) of the physical layer.

FIG. 2 is a flowchart for a data transmission method by an ARQ controller according to an exemplary embodiment of the present invention.

As shown in FIG. 2, the ARQ controller (113 of FIG. 1) determines the data transmission mode according to the QoS of the SDU stored in the buffer (S110), and determines the transmission amount of the service packets according to the determined data transmission mode (S120).

The ARQ controller 113 fragmentizes and concatenates the SDU depending on the data transmission amount determined by a scheduler according to the data transmission method, and generates a fragmentation block (FB) (S130).

The ARQ controller 113 generates a PDU including the generated FB and information on the FB (S140), and adds radio link control information including a PDU retransmission method and the number of fragmentation blocks included in the PDU to the generated PDU to thus generate an RLC data PDU.

The ARQ controller 113 transmits the generated RLC data PDU to the MAC layer (S150).

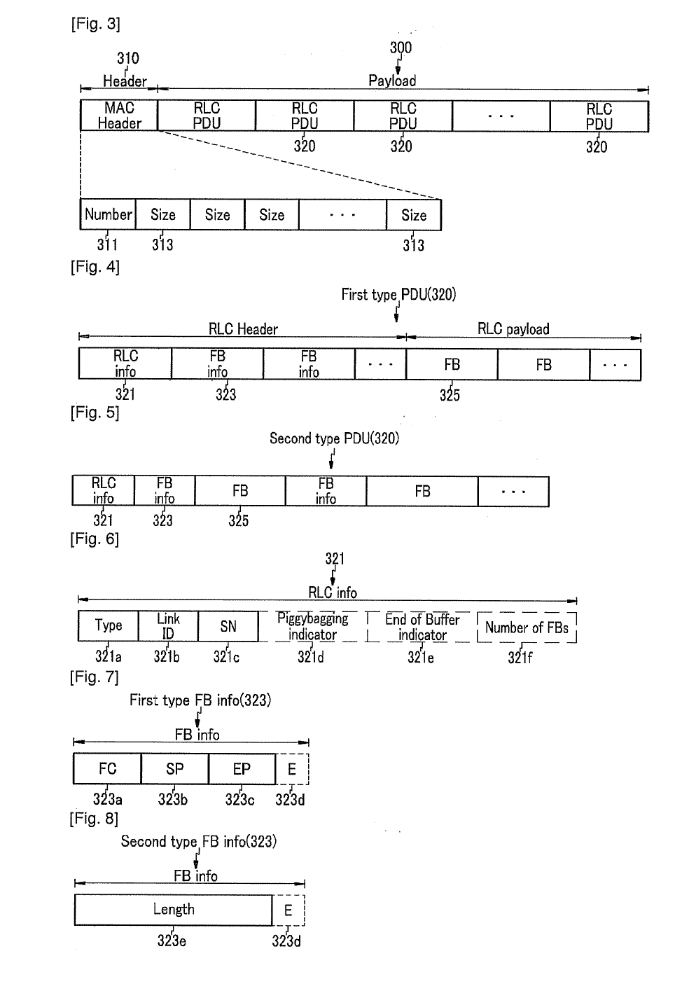

FIG. 3 is a configuration of a TB of a MAC layer and a header field of the TB according to an exemplary embodiment of the present invention.

As shown in FIG. 3, the TB 300 that is transmitted from the MAC layer 120 to the physical layer 130 includes a MAC header field and a payload field, and the payload field includes at least one RLC PDU 320. Here, each RLC PDU 320 is an RLC control PDU or an RLC data PDU.

The MAC header field 310 includes one number field 311 and at least one size field 313, and the number field 311 indicates the number of RLC PDUs 320 included by the TB 300, and the at least one size field 313 indicates the size of the at least one RLC PDU 320 included by the TB 300.

Here, the TB 300 may not have the MAC header field 310.

FIG. 4 and FIG. 5 show a first type and a second type of RLC PDU of a payload field of a TB according to an exemplary embodiment of the present invention.

As shown in FIG. 4, the first type of RLC PDU 320 includes an RLC header field and an RLC payload field, the RLC header field includes an RLC information field 321 and an FB information field 323, and the RLC payload field includes at least one FB 325. The FB information field 323 includes information on each of the FBs 325 included by the RLC payload field.

As shown in FIG. 5, the second type of RLC PDU 320 includes an RLC information field 321, at least one FB information field 323, and at least one FB 325 corresponding to at least one FB information field 323. The FB information field 323 of the second type of RLC PDU field 320 includes information on the FB 325 provided next to the FB information field 323.

FIG. 6 shows an RLC information field of an RLC PDU of a TB according to an exemplary embodiment of the present invention.

As shown in FIG. 6, the RLC information field 321 includes a type field 321a, a link identifier field 321b, and a sequence number field 321c, and further includes a piggybagging indicator field 321d, an end of buffer (EOB) indicator field 321e, and an FB number field 321f.

The type field 321a displays the type of RLC PDU, and includes information for processing to the packet controller, the ARQ, or other layers. Also, the type field 321a displays whether the RLC PDU 320 is a data PDU or a control PDU.

The link identifier field 321b identifies the link to which the RLC PDU 320 belongs in the case of requesting to retransmit the RLC PDU 320, and is an identifier of the corresponding link for operating the ARQ.

The sequence number field 321c indicates a sequence number that is allocated for the ARQ operation to the FB 325.

The piggybagging indicator field 321d indicates that a control PDU is included in the TB 325 in the piggybagging format so as to increase the data transmission efficiency according to the determination of the MAC layer.

The EOB indicator field 321e notifies that the buffer has no more SDU to be transmitted to the lower layer from the upper layer.

The FB number field 321f indicates the entire number of FBs included in the RLC PDU 320 when the number of FBs included in the RLC PDU 320 is plural. The information of the RLC information field 321 can limit the number of bits in consideration of byte-based operation in the realized structure of a high data rate system. For example, the type field 321a is configured to have 3 bits, the link identifier field 321b is configured to have 4 bits, the piggybagging indicator field 321d is configured to have 1 bit, the sequence number field 321c is configured to have 11 bits, the EOB indicator field 321e is configured to have 1 bit, and the FB number field 321f is configured to have 4 bits.

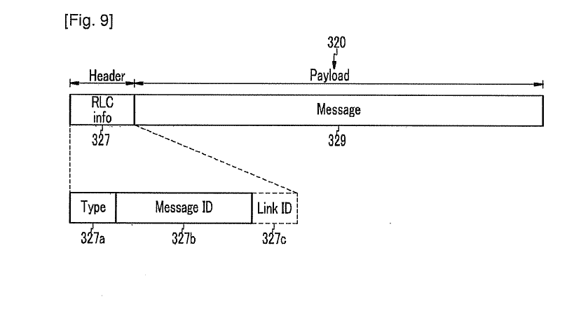

FIG. 7 and FIG. 8 show a first type and a second type of FB information fields of an RLC PDU of a TB according to an exemplary embodiment of the present invention.

As shown in FIG. 7, the first type of FB information field 323 includes a fragmentation control (FC) field 323a, a starting pointer (SP) field 323b, and an ending pointer (EP) field 323c, and further includes an extension indicator (E) field 323d.

The FC field 323a includes fragmentation information on the SDU of a first part, a middle part, and a last part included in the FB, and other control information.

The SP field 323b indicates starting pointer information on the FB included in the RLC PDU 320, and the EP field 323c indicates the ending pointer of the FB included in the RLC PDU 320.

The E field 323d is an indicator for notifying an existence of an additional FB when the RLC PDU 320 has the additional FB.

As shown in FIG. 8, when one FB includes an SDU that is not fragmentized, the type 2 FB information field 323 includes a length field 323e and further includes an E field 323d.

Here, the length field 323c indicates the length of the FB, that is, the length of the SDU, and the E field 323d is an indicator of existence of an additional FB when the RLC PDU 320 has an additional FB.

FIG. 9 shows a configuration of an RLC control PDU according to an exemplary embodiment of the present invention.

As shown in FIG. 9, the RLC control PDU 320 includes an RLC information field 327 and a message field 329.

The RLC information field 327 includes a type field 327a and a message identifier field 327b, and may further include a link identifier field 327c.

The type field 327a indicates the type of the RLC control PDU 320, and includes information on processing for the packet controller, the ARQ controller, or other layers. Here, the type field 327a can indicate whether the RLC PDU 320 is an RLC data PDU or an RLC control PDU.

The message identifier field 327b includes a transmitting object and a receiving object of the RLC control PDU 320.

The link identifier field 327c is an identifier for identifying the link to which the RLC PDU 320 belongs in the case of requesting the receiver to retransmit the RLC PDU 320, and is an identifier of the corresponding link for operating the ARQ.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for transmitting data between layers in a communication system, the method comprising:
determining a transmission method for a service packet according to a quality of service (QoS) of the service packet;
determining a transmission amount of the service packet according to the transmission method;
fragmentizing and concatenating the service packet according to the transmission amount to generate at least one fragmentation block;
generating a data packet including the at least one fragmentation block and information on the at least one fragmentation block;
inserting information on the number of the at least one fragmentation blocks into the data packet; and
transmitting the data packet.

2. The method of claim 1, wherein the determining of the transmission method for the service packet comprises:
selecting one of a transparent mode, an acknowledged mode, and an unacknowledged mode depending on the QoS requested by the service packet.

3. A method for generating a data packet comprising:
fragmentizing and concatenating a service packet of an upper layer according to a transmission amount of a service packet, to generate at least one fragmentation block;
inserting at least one fragmentation block information field each corresponding to the at least one fragmentation block into the data packet;
inserting the at least one fragmentation block into the data packet; and
inserting information on the data packet into the data packet.

4. The method of claim 3, wherein
the inserting of the at least one fragmentation block into the data packet comprises:
inserting the at least one fragmentation block into the data packet after the at least one fragmentation block information field.

5. The method of claim 3, wherein
the inserting of the at least one fragmentation block into the data packet comprises:
inserting the corresponding fragmentation block into the data packet after the at least one fragmentation block information field.

6. The method of claim 3, wherein
the inserting of the at least one fragmentation block information field each corresponding to the at least one fragmentation block into the data packet comprises:
when each of the at least one fragmentation block includes a plurality of service packets, inserting fragmentation information of the plurality of service packets included in the fragmentation block into the fragmentation block information field, and
inserting location information for indicating the insertion location of the fragmentation block at the data packet into the fragmentation block information field.

7. The method of claim 3, wherein
the inserting of the at least one fragmentation block information field each corresponding to the at least one fragmentation block into the data packet comprises:
when each of the at least one fragmentation block includes a service packet, inserting the length of the service packet into the fragmentation block information field.

8. The method of claim 7, further comprising:
inserting information for indicating that an additional fragmentation block in addition to the fragmentation block is provided in the data packet into the fragmentation block information field.

9. The method of claim 3, wherein
the inserting of the data packet information into the data packet comprises:
inserting an order for inserting at least one fragmentation block included in the data packet into the data packet into information on the data packet;
inserting an identifier for identifying a corresponding link into the information on the data packet when a receiver requests to retransmit the data packet; and
inserting type information for processing the data packet to another layer into the information on the data packet.

10. The method of claim 9, further comprising:
inserting the number of fragmentation blocks included in the data packet into the information on the data packet;
inserting an indicator for notifying that there are no more service packets to be transmitted to the lower layer into the information on the data packet; and
inserting an indicator for indicating that a control packet for controlling data transmission of the service packet is a piggybag format into the data packet information.

11. A method for generating a transmission block, comprising:
determining a transmission method for a service packet according to a quality of service (QoS) of the service packet;
fragmentizing and concatenating the service packet according to a transmission amount of the service packet, to generate a fragmentation block;
generating a data packet including the fragmentation block and information on the fragmentation block;
generating a control packet for controlling data transmission according to the transmission method;
generating the transmission block including the at least one data packet and the control packet; and
inserting information on the transmission block into the transmission block.

12. The method of claim 11, wherein the generating of a control packet for controlling data transmission according to the transmission method comprises:
inserting a control message for controlling data transmission of the service packet into the control packet; and
inserting information on the control message into the control packet.

13. The method of claim 12, wherein the inserting of information on the control message into the control packet comprises:
inserting an identifier for identifying the link to which the control packet belongs into the information on the control message;
inserting an identifier for identifying the control message into information on the control message; and
inserting type information for processing the control packet to another layer into the information on the control message.
